(19) United States
(12) Patent Application Publication
(10) Pub. No.: US 2025/0091228 A1
(43) Pub. Date: Mar. 20, 2025

(54) HOLE GRIPPER

(71) Applicant: KRONES AG, Neutraubling (DE)

(72) Inventor: Tobias EHRISMANN, Burglengenfeld (DE)

(21) Appl. No.: 18/888,775

(22) Filed: Sep. 18, 2024

(30) Foreign Application Priority Data
Sep. 18, 2023 (DE) 10 2023 125 154.6

(51) Int. Cl. B25J 15/00

(52) U.S. Cl. CPC B25J 15/0047; B25J 15/0023

(57) ABSTRACT

The invention relates, inter alia, to a hole gripper which has a pressurized air connection, an elastically deformable bellows portion which can be inflated by the application of pressurized air for clamping in a component hole of a component, and a connecting portion with a connecting channel which connects the pressurized air connection and the bellows portion for supplying pressurized air from the pressurized air connection to the bellows portion. The pressurized air connection, the connecting portion, and the bellows portion are integrally connected to one another in one piece.

### CROSS REFERENCE TO RELATED APPLICATIONS

This application claims the benefit under 35 U.S.C. § 119(a) of German Patent Application No. DE 10 2023 125 154.6, filed Sep. 18, 2023 entitled HOLE GRIPPER, and whose entire disclosure is incorporated by reference herein.

### TECHNICAL FIELD

The invention relates to a hole gripper and to a use of a hole gripper. The invention further relates to a method for producing a hole gripper and to a computer program product.

### TECHNICAL BACKGROUND

Hole grippers, such as deep hole grippers, can be used for example, for pick-and-place tasks in the field of robotics, packing and palletizing, etc. A hole gripper usually consists of many individual parts. Through the application of pressurized air, the hole gripper expands into a hole in the object intended for transport (e.g., the mouth of a bottle, etc.) and thus holds it firmly.

A hole gripper can, for example, be equipped with an inflatable bellows. Here, excess pressure can be applied internally, causing the bellows to inflate like a balloon. The bellows can rest against the inner wall of a hole and thus establish frictional contact with the object to be transported.

Alternatively, a hole gripper can for example have an elastically deformable element. Here, a plunger can be pulled or pushed by a pneumatic drive. The plunger can compress the elastically deformable element. This compression can also create a frictional contact with the inner wall of the hole.

A disadvantage of the standard prior art can be that conventional hole grippers usually consist of a large number of components. In addition, these hole grippers can be relatively heavy due to necessary metal components, e.g., for a housing or a pneumatic drive. Further disadvantages can be that it is difficult or impossible to prevent the object held by the hole gripper from tilting or wobbling.

The invention is based upon the object of creating an improved hole gripper with which disadvantages in the prior art can be overcome. Preferably, the hole gripper shall be particularly easy to manufacture, adaptable, and lightweight.

### SUMMARY OF THE INVENTION

The object is achieved by the features of the independent claims. Advantageous developments are specified in the dependent claims and the description.

One aspect of the present disclosure relates to a hole gripper (expansion gripper, bellows gripper, internal gripper), preferably for a container treatment plant. The hole gripper has a pressurized air connection for connecting a pressurized air line. The hole gripper has an elastically deformable (expandable) bellows portion which can be inflated by the application of pressurized air for clamping (e.g., non-positively or positively) in a component hole of a component. The hole gripper has a (e.g., elongated) connecting portion with a connecting channel which connects the pressurized air connection and the bellows portion for supplying pressurized air from the pressurized air connection to the bellows portion. The pressurized air connection, the connecting portion, and the bellows portion are integrally connected to one another in one piece.

The hole gripper advantageously makes it possible to save upon many individual parts, assembly time, and weight. Another advantage is that production can be particularly simple, e.g., using additive manufacturing, and, even in the prototype stage, production costs are very low compared to conventional hole grippers.

In an exemplary embodiment, the pressurized air connection, the connecting portion, and the bellows portion are formed together from a plurality of adjacent, preferably additively manufactured, material layers, preferably from a (e.g., elastically deformable) plastic, e.g., a thermoplastic polyurethane. As already mentioned, additive manufacturing can be particularly advantageous for producing a one-piece body consisting of a pressurized air connection, a connecting portion, and a bellows portion. Additive manufacturing can also enable individual customization of the hole gripper geometries, even for extremely small quantities down to a piece count of one unit. This means that the perfect gripper (e.g., shape, stud ring(s), undercut, etc.) can always be configured for the individual application. By choosing a lightweight material, advantageously higher masses can be moved, faster cycle times can be achieved, and the application can be made more efficient overall.

In a further exemplary embodiment, the pressurized air connection, the connecting portion, and the bellows portion are made of the same material, preferably a (e.g., elastically deformable) plastic, e.g., a thermoplastic polyurethane. Preferably, the bellows portion can be inflated by the application of pressurized air due to its smaller wall thickness than the connecting portion and the pressurized air connection. This advantageously enables simple production which can reliably provide the function of the inflatable bellows portion.

In one embodiment, the connecting portion has a casing and/or an inner core, preferably a solid core or a hollow core. Optionally, the connecting channel, preferably annular, can extend between the casing and the inner core. Advantageously, this enables a suitable and reliable construction of the connecting channel and the connecting portion.

In a further embodiment, the casing, the inner core, and the connecting channel are arranged coaxially to one another. Alternatively or additionally, the casing is substantially tubular. Alternatively or additionally, the inner core is substantially cylindrical or tubular. Alternatively or additionally, the casing merges into an outer wall of the bellows portion. Alternatively or additionally, the inner core extends inwardly from an outer wall of the bellows portion to form a chamber for the pressurized air between the inner core and the outer wall. This advantageously enables a particularly suitable and reliable structure of the connecting channel, the connecting portion, and the bellows portion.

In a further variant embodiment, the casing has a greater wall thickness than an outer wall of the bellows portion. In this way, it is advantageously possible to ensure that the bellows portion can inflate when pressurized air is applied, while the casing withstands the pressurized air, without it being necessary for the casing to be made of a different material than the outer wall of the bellows portion.

However, it is also possible, for example, for the casing and the outer wall of the bellows portion to have substantially the same wall thickness. To withstand the application of the pressurized air, the casing can be reinforced, for example, by connecting webs with the inner core and/or by ribbing and/or by an external support-for example, a housing.

In one exemplary embodiment, the connecting portion further has a plurality of connecting webs that support the casing and the inner core against one another. Optionally, the plurality of connecting webs can be spaced apart along a longitudinal axis of the hole gripper and/or around an outer circumference of the inner core. Alternatively or additionally, the plurality of connecting webs can extend, for example, through the connecting channel. This can advantageously significantly improve the stability of the hole gripper, and the casing can better withstand the pressurized air pressure.

In one exemplary embodiment, the hole gripper further has a preferably metallic stabilizer rod which extends longitudinally through the connecting portion, preferably through a tubular inner core of the connecting portion, preferably coaxially to a longitudinal axis of the hole gripper. The integral, one-piece configuration of the pressurized air connection, the connecting section, and the bellows section can in this way advantageously be reinforced and stabilized. For example, after the additive manufacturing of the one-piece body consisting of the pressurized air connection, connecting portion, and bellows portion, the stabilizer rod can be inserted into the one-piece body and secured thereinfor example, with a positive fit, a non-positive fit, and/or a material fit.

In a further exemplary embodiment, the stabilizer rod has a (e.g., pointed or blunt) centering portion for centering the hole gripper when inserting it into the component hole. This can advantageously ensure better functionality of the hole gripper on the one hand, and enable functional integration in the stabilizer rod on the other.

Preferably, the centering portion can be arranged at an end, projecting beyond the bellows portion, of the stabilizer rod.

In a further exemplary embodiment, the hole gripper has a (e.g., pointed or blunt) centering portion for centering the hole gripper when inserting it into the component hole. Preferably, the pressurized air connection, the bellows portion, the connecting portion, and the centering portion can be integrally connected to one another in one piece. Alternatively or additionally, for example, the pressurized air connection, the connecting portion, the bellows portion, and the centering portion can be formed together from a plurality of adjacent, preferably additively manufactured, material layers, preferably from a (e.g., elastically deformable) plastic, preferably a thermoplastic polyurethane. This can advantageously ensure, on the one hand, a better functionality of the hole gripper, and, on the other, the additional function of centering in the one-piece body can be added in a particularly simple, e.g., additively producible, manner.

In one embodiment, the outer lateral face is essentially shaped as a frustoconical lateral face or a cylindrical lateral face. A truncated cone lateral face can advantageously support a centering function, for example, whereas a cylindrical lateral face can be particularly advantageous for preventing the gripped component from wobbling or tilting, e.g., during dynamic movements or when pivoting in a horizontal plane.

In one embodiment, the outer lateral face can be textured (for example, with a predetermined texture) and/or profiled (for example, with a predetermined profiling). Alternatively or additionally, the outer lateral face can have studs, teeth, ribs, or webs. Alternatively or additionally, the outer lateral face can have at least one partially or completely circumferential collar (e.g., coaxial to a longitudinal axis of the hole gripper).

Advantageously, this can improve the frictional connection between the bellows portion and the component hole, and/or enable an undercut for engagement behind the component hole or component, thus enabling higher holding forces. By profiling with, for example, webs or ribs, a greater wall thickness can be advantageously permitted in the region of the profiling in order to achieve, for example, a firmer contact face relative to the component hole.

Preferably, the texturing and/or profiling can be directly manufactured additively during the additive manufacturing of the bellows portion. This advantageously allows a particularly simple production of the texturing and/or profiling, without the need for a separate production step.

In a further embodiment, the pressurized air connection can be arranged coaxially to a longitudinal axis of the hole gripper. This is advantageous because it enables a particularly simple and reliable configuration of the hole gripper.

Alternatively, the pressurized air connection can be arranged at an angle, preferably at a right angle, to a longitudinal axis of the hole gripper. This can advantageously be used to create space for a reinforcing component, such as a stabilizer rod.

In a variant embodiment, the hole gripper further has a (e.g., multi-part) housing in which the connecting portion is received, preferably in a positively fitting manner, at least in portions. Particularly preferably, the bellows portion and optionally the centering portion can be arranged outside the housing. Preferably, the casing and an outer wall of the bellows portion can have a substantially equal wall thickness. This advantageously makes it possible, for example, for the pressurized air connection and/or the connecting portion to be realized with comparatively thin walls, since the housing enables support from the outside. This means that the connecting portion can, for example, withstand the pressure from the pressurized air without itself being made particularly stable.

For example, the optional stabilizer rod can be supported directly on the housing.

A further aspect of the present disclosure relates to a handling apparatus, preferably a handling robot (e.g., changing robot), having the hole gripper.

For example, the handling apparatus can be a stationary or mobile robot or any other type of handling apparatus. Preferably, the handling apparatus can have at least one pivotable and/or displaceable arm. Optionally, the hole gripper can be attached to and carried by the arm, e.g., at one end of the arm.

Another aspect of the present disclosure relates to a use of a hole gripper as disclosed herein in a container treatment plant, preferably for gripping a container turntable.

Another aspect of the present disclosure relates to a container treatment plant (e.g., for manufacturing, cleaning, coating, testing, filling, sealing, labeling, printing, marking, laser marking, and/or packaging containers for liquid media, preferably beverages or liquid foodstuffs) having a hole gripper as disclosed herein or a handling device as disclosed herein.

For example, the containers can be realized as bottles, cans, canisters, cartons, vials, tubes, etc.

Another aspect of the present disclosure relates to a method for producing a hole gripper for example, as disclosed herein. The method features an additive manufacturing of the pressurized air connection, the connecting portion, and the bellows portion to form a one-piece body, preferably in a powder bed method and/or from a (e.g., elastically deformable) plastic, preferably a thermoplastic polyurethane. Advantageously, the method can achieve the same advantages as already described with reference to the hole gripper.

A further aspect of the present disclosure relates to a computer program product having instructions (for example, at least one computer-readable storage medium having instructions stored thereon) that cause an additive manufacturing apparatus (e.g., 3-D printer) to produce a hole gripper as disclosed herein in a plurality of layers in an additive manufacturing method, preferably a powder bed method, or to carry out a method as disclosed herein.

The preferred embodiments and features of the invention described above can be combined with one another as desired.

### BRIEF DESCRIPTION OF THE FIGURES

Further details and advantages of the invention are described below with reference to the accompanying drawings. In the figures:

FIG. 1 is a perspectival view of a hole gripper according to an exemplary embodiment of the present disclosure;

FIG. 2 is a perspectival sectional view of the exemplary hole gripper of FIG. 1;

FIG. 3 is a sectional view of the exemplary hole gripper of FIG. 1 in engagement with a component;

FIG. 4 is a perspectival view of an exemplary bellows portion;

FIG. 5 is a perspectival view of a further exemplary bellows portion;

FIG. 6 is a perspectival view of a further, other exemplary bellows portion;

FIG. 7 is a sectional view of a hole gripper according to an exemplary embodiment of the present disclosure in engagement with a component;

FIG. 8 is a sectional view of a hole gripper according to an exemplary embodiment of the present disclosure in engagement with a component;

FIG. 9 is a perspectival view of a hole gripper according to an exemplary embodiment of the present disclosure;

FIG. 10 is a perspectival view of a one-piece body of the exemplary hole gripper of FIG. 9; and

FIG. 11 is a sectional view of the exemplary hole gripper of FIG. 9 in engagement with a component.

The embodiments shown in the figures correspond at least in part, so that similar or identical parts are provided with the same reference signs and reference is also made to the description of other embodiments or figures for the explanation thereof to avoid repetition.

### DETAILED DESCRIPTION OF EXEMPLARY EMBODIMENTS

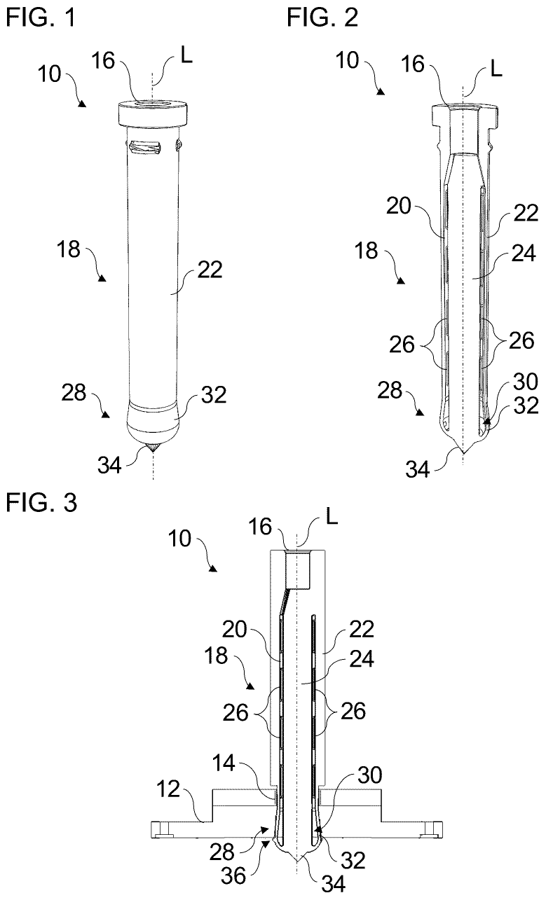

FIGS. 1 to 3 show a hole gripper 10. Preferably, the hole gripper 10 is configured as a so-called deep hole gripper. The hole gripper 10 can also be referred to as an expansion gripper, a bellows gripper, or an internal gripper.

As shown in FIG. 3 as an example, a component 12 can be gripped and handled with the hole gripper 10. The hole gripper 10 can grip the component 12 in or on a component hole 14 of the component 12. The hole gripper 10 can clamp itself in the component hole 14 with a positive fit and a non-positive fit. The clamped component 12 can be moved together with the hole gripper 10.

Preferably, the hole gripper 10 can be used in a container treatment plant. For example, the component 12 can be configured as a container turntable. It is also possible for the hole gripper 10 to be used to grip containers, fitting parts, or format parts in a container treatment plant. It is also possible for the hole gripper 10 to be used in an environment other than a container treatment plant to grip any component 12 having a component hole 14.

The hole gripper 10 can be carried by any handling apparatus as a gripping tool. For example, the hole gripper 10 can be an end effector of a handling robot, such as a changing robot, or another handling apparatus.

The hole gripper 10 can be a substantially elongated, preferably one-piece, component. The hole gripper 10 can have a (e.g., central) longitudinal axis L.

The hole gripper 10 has a pressurized air connection 16, a connecting portion 18, and a bellows portion 28. Optionally, the hole gripper 10 can, for example, also have a centering portion 34.

The pressurized air connection 16, the connecting portion 18, the bellows portion 28, and optionally the centering portion 34 are integrally connected to one another in one piece. The pressurized air connection 16, the connecting portion 18, the bellows portion 28, and optionally the centering portion 34 can together form a one-piece body. It is also possible for the centering portion 34 to be present but not integrally connected to the pressurized air connection 16, the connecting portion 18, and the bellows portion 28, or not form a one-piece body with them.

Particularly preferably, the one-piece body can be formed from a plurality of adjacent, additively manufactured material layers. Preferably, the one-piece body can be additively manufactured in a powder bed method. In detail, the pressurized air connection 16, the connecting portion 18, the bellows portion 28, and optionally the centering portion 34 can be formed together from a plurality of adjacent, additively manufactured material layers. Preferably, the material layers can be made of a plastic, preferably of a thermoplastic polyurethane.

Instructions for causing an additive manufacturing device to additively manufacture the hole gripper 10 or the one-piece body made of the pressurized air connection 16, connecting portion 18, bellows portion 28, and, optionally, centering portion 34 can be stored in a computer program product (e.g., file(s) or data carrier with file(s)).

A pressurized air line can be connected to the pressurized air connection 16 (not shown in the figures). The hole gripper 10 can be actuated via the pressurized air line. The pressurized air line can be detachably connected to the pressurized air connection 16. For example, the pressurized air line can be connected to the pressurized air connection 16 with a positive fit and/or a non-positive fit. For example, the pressurized air connection 16 and the pressurized air line can be detachably connected to one another via a screw or clamp connection.

The pressurized air connection 16 can be arranged at one end of the hole gripper 10. The end is preferably an end, opposite the component 12 to be gripped, of the hole gripper 10.

The pressurized air connection 16 can be arranged coaxially to the longitudinal axis L of the hole gripper 10.

It is possible for the pressurized air connection 16 to also serve for mounting the hole gripper 10 on the handling apparatus (not shown in the figures). Alternatively or additionally, the hole gripper 10 can, for example, have an additional assembly portion for the preferably non-positive-fitting and/or positive-fitting mounting of the hole gripper 10 on the handling apparatus.

The connecting portion 18 can connect the pressurized air connection 16 and the bellows portion 28 to one another. The connecting portion 18 can be elongated. The connecting portion 18 can be arranged between the pressurized air connection 16 and the bellows portion 28.

The connecting portion 18 has a (pressurized air) connecting channel 20. Optionally, the connecting portion 18 can, for example, also have a casing 22, an inner core 24, and/or a plurality of connecting webs 26.

The connecting channel 20 connects the pressurized air connection 16 and the bellows portion 28 with each other. The pressurized air connection 16 can open into the connecting channel 20. The connecting channel 20 can open into the bellows portion 28, e.g., into its chamber 30.

Pressurized air can be supplied from the pressurized air connection 16 to the bellows portion 28 via the connecting channel 20. Preferably, the bellows portion 28 can also be relieved via the connecting channel 20 and the pressurized air connection 16.

The connecting channel 20 can extend parallel, preferably coaxially, to the longitudinal axis L of the hole gripper 10.

The connecting channel 20 can be annular, or configured as an annular channel. Preferably, the connecting channel 20 can be formed as a substantially annular cavity between the casing 22 and the inner core 24.

The casing 22 can be substantially tubular. The casing 22 can preferably extend coaxially to the longitudinal axis L of the hole gripper 10. The casing 22 can encase or enclose the connecting channel 20 and the inner core 24.

As shown in FIGS. 1 to 3, the inner core 24 can be configured as a solid core. The solid core can be substantially cylindrical in shape. Alternatively, the inner core 24 can be configured for example as a hollow core. The hollow core can for example be substantially tubular.

The inner core 24, the connecting channel 20, and the casing 22 can be arranged coaxially to each other; with the connecting channel 20 within the casing 22 and with the inner core 24 within the connecting channel 20.

The connecting webs 26 can support the casing 22 and the inner core 24 against each other. The connecting webs 26 can be arranged between the casing 22 and the inner core 24. The connecting webs 26 can connect the casing 22 and the inner core 24 to each other. The connecting webs 26 can extend through the connecting channel 20.

The connecting webs 26 can each, on the one hand, merge into an inner peripheral face of the casing 22. The connecting webs 26 can each, on the other hand, merge into an outer circumference of the inner core 24. The connecting webs 26 can be arranged at a distance from one another along the longitudinal axis L of the hole gripper 10. Alternatively or additionally, the connecting webs 26 can be arranged at a distance from one another around an outer circumference of the inner core 24 or around an inner circumference of the casing 22.

Preferably, a plurality (e.g., four) of groups are comprised of connecting webs 26. The groups can be arranged at a distance from one another along the longitudinal axis L of the hole gripper 10. Each group can have a plurality of connecting webs 26, which can be arranged at a distance from one another around an outer circumference of the inner core 24 or around an inner circumference of the casing 22.

Preferably, the connecting webs 26 are each elongated. The longitudinal axes of the connecting webs 26 are preferably parallel to the longitudinal axis L of the hole gripper 10.

The bellows portion 28 is elastically deformable or expandable. The bellows portion 28 is inflatable by the application of pressurized air for clamping in the component hole 14. To inflate the bellows portion 28, pressurized air can be supplied from the pressurized air connection 16 via the connecting channel 20 to the bellows portion 28.

The bellows portion 28 can have a bellows shape. The bellows shape can for example be rotationally symmetrical. Alternatively, the bellows shape can have any other suitable shape, e.g., with a slot-shaped, oblong-hole-shaped, or polygonal (e.g., square-shaped) cross-section.

The bellows portion 28 can preferably be formed by a preferably annular chamber 30 and an outer wall 32.

Preferably, the connecting channel 20 can open into the chamber 30. For example, the chamber 30 can annularly surround a portion of the inner core 24. Preferably, the chamber 30 can be arranged coaxially to the longitudinal axis L.

Preferably, the outer wall 32 can be tubular. Preferably, the outer wall 32 can surround the chamber 30. When pressurized air is applied to the chamber 30, the outer wall 32 can be expanded or inflated radially outwards with respect to the longitudinal axis L, for example.

The outer wall 32 can merge into the casing 22. The outer wall 32 can extend the casing 22 in a direction towards a free end of the hole gripper 10.

Due to its smaller wall thickness than the connecting portion 18 and the pressurized air connection 16, the bellows portion 28 can be inflated by the application of pressurized air. For example, the outer wall 32 of the bellows portion 28 can have a smaller wall thickness than the casing 22 of the connecting portion 18.

The outer wall 32 can, for example, have a wall thickness of ≤2 mm or ≤1.5 mm or ≤1 mm.

The bellows portion 28/the outer wall 32 can widen and/or taper along the longitudinal axis L towards a free end of the hole gripper 10. For example, the bellows portion 28/the outer wall 32 can have a frustoconical shape. Preferably, the bellows portion 28/the outer wall 32 can expand along the longitudinal axis L in a direction towards a free end of the hole gripper 10.

Alternatively, the bellows portion 28/the outer wall 32 can be cylindrical, for example. The outer wall 32 can have a constant diameter along the longitudinal axis L.

The centering portion 34 can serve to center the hole gripper 10 when inserting it into the component hole 14. For example, the centering portion 34 can be pointed, e.g., pointed-cone-shaped, or blunt, e.g., frustoconical.

The centering portion 34 can be arranged at a free end of the hole gripper 10. The centering portion 34 can merge into the inner core 24 and/or into the bellows portion 28, preferably its outer wall 32.

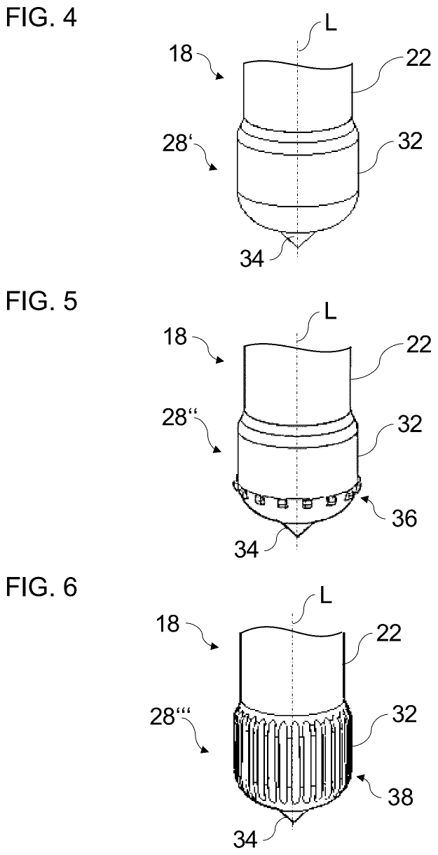

FIGS. 4 to 6 show different variants of the bellows portion 28 which can be combined with one another as desired.

FIG. 4 shows a bellows portion 28′ which is substantially cylindrical.

An outer lateral face of the outer wall 32 can substantially correspond to a cylinder lateral face. Alternatively, an outer lateral face of the outer wall 32 can, for example, substantially be a truncated cone face (see also FIGS. 1 to 3).

FIG. 5 shows a bellows portion 28″ which has an outer wall 32 with a profiled outer lateral face.

The outer lateral face can have a plurality of studs 36. The studs 36 can, for example, be configured as teeth. Preferably, the studs 36 can be arranged in one or more rings, which can be spaced apart from one another along the longitudinal axis L. The studs 36 can be distributed around a circumference of the outer lateral face, preferably equidistantly.

Preferably, the studs 36 can be arranged at an end, facing the free end of the hole gripper 10, of the bellows portion 28″. Preferably, the studs 36 can thus form an undercut in order to be able to engage behind the component hole 14 to improve the gripping effect (see also FIG. 3).

Alternatively, an undercut can be formed, for example, by a partially or completely circumferential collar (flange) of the outer lateral face. Preferably, the collar can be arranged at an end, facing the free end of the hole gripper 10, of the bellows portion 28″.

FIG. 6 shows a bellows portion 28″ which has an outer wall 32 with a profiled outer lateral face.

The outer lateral face can have a plurality of ribs (webs) 38. Preferably, the ribs 38 can be arranged in one or more rings which can be spaced apart along the longitudinal axis L. The ribs 38 can be distributed, preferably equidistantly, around a circumference of the outer lateral face. Longitudinal axes of the ribs 38 can preferably be parallel to the longitudinal axis L of the hole gripper 10.

Alternatively or in addition to a profiling of the outer lateral face, it is also possible, for example, for the outer lateral face of the outer wall 32 to be textured with a predetermined texture.

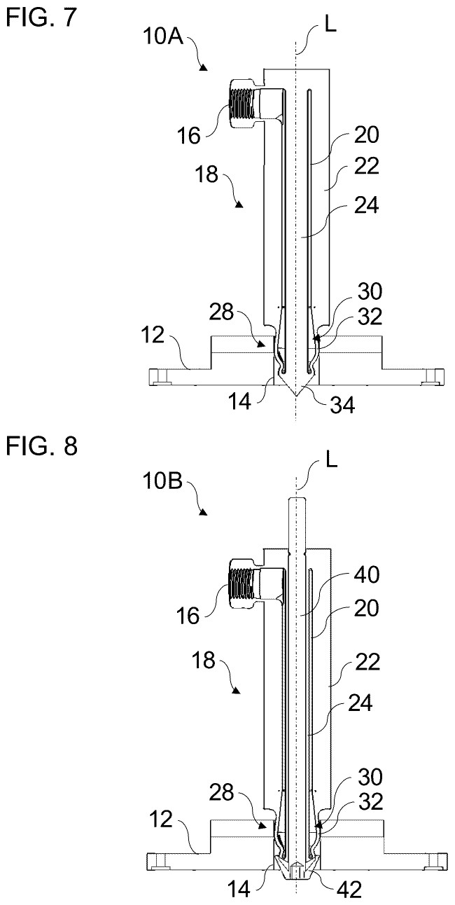

FIG. 7 shows a hole gripper 10A with a pressurized air connection 16.

The pressurized air connection 16 can be arranged or aligned at an angle to the longitudinal axis L of the hole gripper 10A. Preferably, the pressurized air connection 16 can be arranged at a right angle to the longitudinal axis L of the hole gripper 10A.

FIG. 8 shows a hole gripper 10B with a stabilizer rod 40.

The stabilizer rod 40 can extend through the connecting portion 18. Preferably, the stabilizer rod 40 can extend through the hollow inner core 24, preferably up to a free end of the hole gripper 10B. Specifically, the inner core 24 can have a receiving channel in which the stabilizer rod 40 is received.

The stabilizer rod 40 can extend parallel, preferably coaxially, to the longitudinal axis L of the hole gripper 10B. For example, the stabilizer rod 40 can extend between opposite ends of the hole gripper 10B.

The stabilizer rod 40 can preferably be a solid rod. Preferably, the stabilizer rod 40 can be metallic.

Preferably, the stabilizer rod 40 can have a centering portion 42 for centering the hole gripper 10B when inserted into the component hole 14. For example, the centering portion 42 can be pointed, e.g., pointed-cone-shaped, or blunt, e.g., frustoconical. Preferably, the centering portion 42 can be arranged in an end region, projecting beyond the bellows portion 28 along the longitudinal axis L of the hole gripper 10, of the stabilizer rod 40.

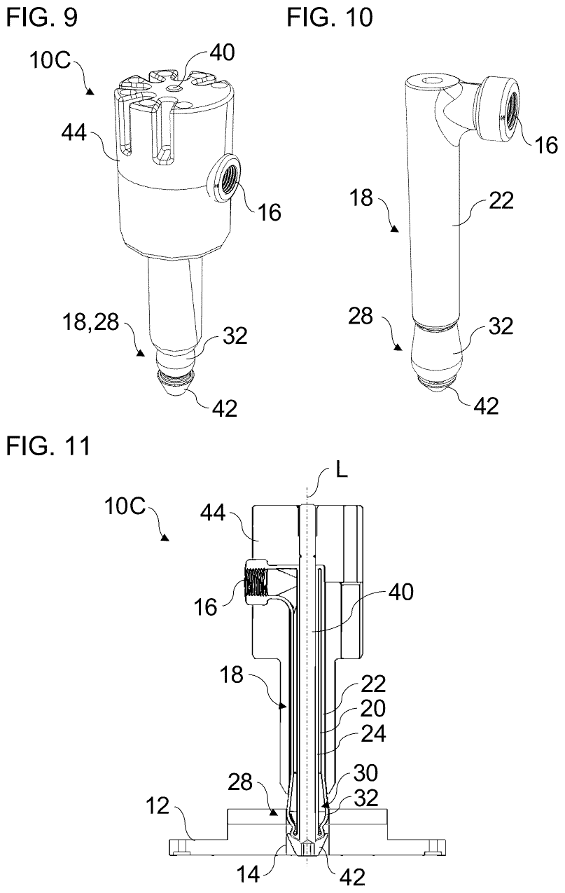

FIGS. 9 to 11 show a hole gripper 10C with a housing 44.

Preferably, the housing 44 can receive the pressurized air connection 16 and the connecting portion 18 and, optionally, the stabilizer rod 40, each at least in portions.

Preferably, the bellows portion 28 is arranged completely outside the housing 44. Particularly preferably, the connecting portion 18 is received in the housing 44 up to a transition to the bellows portion 28. The optional centering portion 42 (or 34) can also be arranged outside the housing 44.

Preferably, the connecting portion 18 and, optionally, the pressurized air connection 16 can be received in the housing 44 with a positive fit. For example, an inner receiving chamber of the housing 44 can be matched in its shape to an outer shape of the pressurized air connection 16 and/or the connecting portion 18.

Preferably, the housing 44 is made up of a plurality of parts, e.g., two parts. A join line of the housing 44 can be arranged, for example, in the region of the pressurized air connection 16. For example, the housing 44 can be formed from a plurality of, for example, two, housing shells. The housing parts or shells can be detachably fastened to one another, e.g., by means of screw connection(s). Preferably, the housing shells can be configured as housing half-shells.

It will be understood that the individual features of the hole grippers 10, 10A, 10B, and 10C can be combined and exchanged as desired.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed independently of all of the features of independent claim 1 and, for example, independently of the features relating to the presence and/or the configuration of the pressurized air connection, the connecting portion, and/or the bellows portion of independent claim 1. All ranges specified herein are to be understood as disclosed in such a way that all values falling within the respective range are individually disclosed, e.g., also as the respective preferred narrower outer limits of the respective range.

### LIST OF REFERENCE SIGNS

10 hole gripper
12 component
14 component hole
16 pressurized air connection
18 connecting portion
20 connecting channel
22 casing
24 inner core
26 connecting web
28 bellows portion
30 chamber
32 outer wall
34 centering portion
36 studs
38 ribs
40 stabilizer rod
42 centering portion
44 housing
L longitudinal axis

What is claimed is:

1. A hole gripper, wherein the hole gripper has:
a pressurized air connection for connecting a pressurized air line;
an elastically deformable bellows portion which can be inflated by the application of pressurized air for clamping in a component hole of a component; and
a connecting portion with a connecting channel which connects the pressurized air connection and the bellows portion for supplying pressurized air from the pressurized air connection to the bellows portion,
wherein the pressurized air connection, the connecting portion, and the bellows portion are integrally connected to one another in one piece.

2. The hole gripper according to claim 1, wherein at least one of:
the pressurized air connection, the connecting portion, and the bellows portion are formed together from a plurality of adjacent material layers; and
the pressurized air connection, the connecting portion, and the bellows portion are made of the same material, and the bellows portion is inflatable when pressurized with pressurized air due to its smaller wall thickness than the connecting portion and the pressurized air connection.

3. The hole gripper according to claim 2, wherein at least one of:
the hole gripper is for a container treatment plant;
the plurality of adjacent material layers are additively manufactured from a plastic; and
the plurality of adjacent material layers are additively manufactured from a thermoplastic polyurethane.

4. The hole gripper according to claim 1, wherein:
the connecting portion has a casing and an inner core; and
the connecting channel extends between the casing and the inner core.

5. The hole gripper according to claim 4, wherein the inner core is one of a solid core and a hollow core, and the connecting channel extends annularly between the casing and the inner core.

6. The hole gripper according to claim 4, wherein at least one of the following is fulfilled:
the casing, the inner core, and the connecting channel are arranged coaxially to one another;
the casing is substantially tubular;
the inner core is substantially cylindrical or tubular;
the casing merges into an outer wall of the bellows portion;
the inner core extends inwardly from an outer wall of the bellows portion to form a chamber for the pressurized air between the inner core and the outer wall; and
the casing has a greater wall thickness than an outer wall of the bellows portion.

7. The hole gripper according to claim 1, wherein:
the connecting portion further has a plurality of connecting webs which support the casing and the inner core against one another.

8. The hole gripper according to claim 7, wherein at least one of:
the plurality of connecting webs are arranged spaced apart from one another at least one of along a longitudinal axis of the hole gripper and around an outer circumference of the inner core; and
the plurality of connecting webs extend through the connecting channel.

9. The hole gripper according to claim 1, further having:
a stabilizer rod which extends longitudinally through the connecting portion.

10. The hole gripper according to claim 9, wherein:
the stabilizer rod has a centering portion for centering the hole gripper when inserting it into the component hole.

11. The hole gripper according to claim 1, further having a metallic stabilizer rod which extends longitudinally through a tubular inner core of the connecting portion coaxially to a longitudinal axis of the hole gripper.

12. The hole gripper according to claim 1, further having:
a centering portion for centering the hole gripper when inserting it into the component hole.

13. The hole gripper according to claim 12, wherein at least one of:
the pressurized air connection, the bellows portion, the connecting portion, and the centering portion are integrally connected to one another in one piece; and
the pressurized air connection, the connecting portion, the bellows portion, and the centering portion are jointly formed from a plurality of adjacent material layers.

14. The hole gripper according to claim 1, wherein the bellows portion has an outer lateral face and at least one of the following is fulfilled:
the outer lateral face is essentially shaped as a frustoconical lateral face or a cylindrical lateral face;
the outer lateral face is at least one of textured and profiled;
the outer lateral face has studs, teeth, ribs, or webs; and
the outer lateral face has at least one partially or completely circumferential collar.

15. The hole gripper according to claim 1, wherein one of:
the pressurized air connection is arranged coaxially to a longitudinal axis of the hole gripper; and
the pressurized air connection is arranged at an angle to a longitudinal axis of the hole gripper.

16. The hole gripper according to claim 1, further having:
a housing in which the connecting portion is received at least in portions, wherein the bellows portion is arranged outside the housing.

17. The hole gripper according to claim 1, wherein at least one of:
the hole gripper further includes a housing in which the connecting portion is received in a positively fitting manner at least in portions,
the casing and an outer wall of the bellows portion have a substantially equal wall thickness, and
the pressurized air connection is arranged at a right angle to a longitudinal axis of the hole gripper.

18. A use of a hole gripper according to claim 1 in a container treatment plant.

19. A method for producing a hole gripper according to claim 1, having:
additive manufacturing of the pressurized air connection, the connecting portion, and the bellows portion to form a one-piece body.

20. A computer program product having instructions causing an additive manufacturing apparatus to:
produce a hole gripper according to claim 1 in a plurality of layers in an additive manufacturing method.
